(19) United States
(12) Patent Application Publication
(10) Pub. No.: US 2003/0103035 A1
(43) Pub. Date: Jun. 5, 2003

(54) Computer with slidable built-in unit

(75) Inventors: Kazutoshi Watanabe, Fukushima-ken (JP); Hirofumi Niitsuma, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/303,545

(22) Filed: Nov. 25, 2002

(30) Foreign Application Priority Data
Dec. 4, 2001 (JP) 2001-369597

(51) Int. Cl. G09G 5/00

(52) U.S. Cl. 345/156

(57) ABSTRACT

A computer having a built-in device incorporated inside an accommodation space of a base. The built-in device has a tray, with a numerical keypad being provided on the tray. A switching device for transmitting a numerical keypad operation signal to a circuit in the base when the tray has slid to a protruding position from an accommodation position is provided.

### BACKGROUND OF THE INVENTION

1. Field of the Invention

The present invention relates to a computer, such as a notebook computer, and, more particularly, to a computer which makes it possible to efficiently use, for example, an input device, such as a numerical keypad, or a recording medium driving device.

2. Description of the Related Art

A notebook computer incorporates drives, which are recording medium driving devices, as built-in devices. Examples of drives are FD (floppy (R) disc) drives and CD (compact disc) drives. The FD drive or the CD drive is installed in a drive accommodation space, which is provided in a side surface of a case of the computer.

This type of computer has various connection terminals provided at a side surface of the case for connecting various peripheral devices for external connection, and the various peripheral devices are connected in accordance with the shapes of the connection terminals.

Due to installation space, the number of keys that are installed in a keyboard is restricted in the related notebook computer compared to that in a desktop computer having the body and the keyboard separately installed, so that a numerical keypad cannot be separately provided. Therefore, a numerical keypad input operation is made possible by switching some of the keys of the keyboard to the keys of the numerical keypad. However, when the input operation based on this switching method is carried out, other key operations cannot be carried out, and this key input operation is difficult to perform. For example, in the notebook type, keys are used as numerical keys, letter keys, and symbolic keys. When a “Num Lock” key is pressed, letter keys are switched to numerical keys, but, at this time, other letter keys are also switched to, for example, Roman character keys. Therefore, when, while inputting letters using a word processor software, numbers are input or numerical calculations are recorded in continuation with the inputting of letters, the state of the “Num Lock” key must be switched whenever necessary, thereby making the input operations very inconvenient.

To overcome such a problem, in the notebook computer, when numbers are frequently used, a new numerical keypad for external connection is purchased and connected to a predetermined port of a terminal for use. However, in this case, space for installing the numerical keypad is required, so that a person may not be able to use the numerical keypad at a place where the installation space is limited, such as in a train, and the notebook computer becomes less portable.

In the notebook computer, since peripheral devices cannot be built in. This makes it necessary to provide a wide installation space when various types of peripheral devices are to be connected, and makes it inconvenient when moving the notebook computer. Stick-type or pad-type pointing devices installed in the computer are difficult to operate compared to mouse-type point devices, particularly, when delicate operations need to be carried out.

### SUMMARY OF THE INVENTION

The present invention makes it possible to overcome the above-described problems, and has as its object the provision of a computer which makes it possible to easily input numbers even while inputting characters or symbols without providing installation space.

It is another object of the present invention to provide a computer which makes it possible to carry out various input operations within a limited space.

To these ends, according to one aspect of the present invention, there is provided a computer comprising a base having a key input section; a built-in unit provided at a side portion of the base, the built-in unit being capable of sliding between an accommodation position where the built-in unit is accommodated inside an accommodation space inside the base and a protruding position where the built-in unit protrudes from the inside of the base, the built-in unit including an input section having a numerical keypad; and switching means, disposed between the base and the built-in unit, for performing a switching operation so that, when the built-in unit is at the protruding position, a numerical keypad operation signal from any one of the numerical keypad keys can be applied to a circuit in the base.

In this computer, numbers can be input by making the built-in unit protrude and by operating the numerical keypad. By this, for example, while operating the key input section at the base, numbers can be input using the built-in unit.

In particular, the present invention is effective when an input section exclusively for a numerical keypad is provided at the key input section at the base.

It is desirable that, with the built-in unit being protruded, numbers can be input using the built-in unit without operating a “Num Lock” key of the key input section at the base.

According to another aspect of the present invention, there is provided a computer comprising a base having a key input section; a built-in unit provided at a side portion of the base, the built-in unit being capable of sliding between an accommodation position where the built-in unit is accommodated inside an accommodation space inside the base and a protruding position where the built-in unit protrudes from the inside of the base, the built-in unit being such that various types of input devices can be replaceably mounted thereto; and switching means, disposed between, the base and the built-in unit, for performing a switching operation so that, when the built-in unit is at the protruding position, an operation signal of the input device can be applied to a circuit in the base.

In the computer, when the built-in unit is protruded, the input device set on the built-in unit can be replaced, so that various input operations can be carried out within a limited space.

Although not exclusive, a recording medium driving device may be settable onto the built-in unit.

In the aspects and forms of the aspects of the present invention, the state of a device on the built-in unit and a circuit inside the base is switched to an electrical conduction state when the built-in unit is protruded, so that a signal of the recording medium driving device or the input device, such as a numerical keypad, set on the built-in unit that is accommodated does not adversely affect the circuit in the base.

In particular, the present invention is effective when the base is a portion of a notebook personal computer.

Although not exclusive, the built-in unit may be mountable to and removable from the base.

### BRIEF DESCRIPTION OF THE DRAWINGS

FIG. 1 is a perspective view of a computer incorporating a built-in device of a first embodiment of the present invention;

FIG. 2 is a plan view showing a state resulting from drawing out the built-in device of the computer of the first embodiment of the present invention;

FIG. 3 is a sectional view taken along line III-III of FIG. 2;

FIG. 4 a conceptual diagram of a computer of a second embodiment of the present invention; and

FIG. 5 is a perspective view of a computer of a third embodiment of the present invention.

### DESCRIPTION OF THE PREFERRED EMBODIMENTS

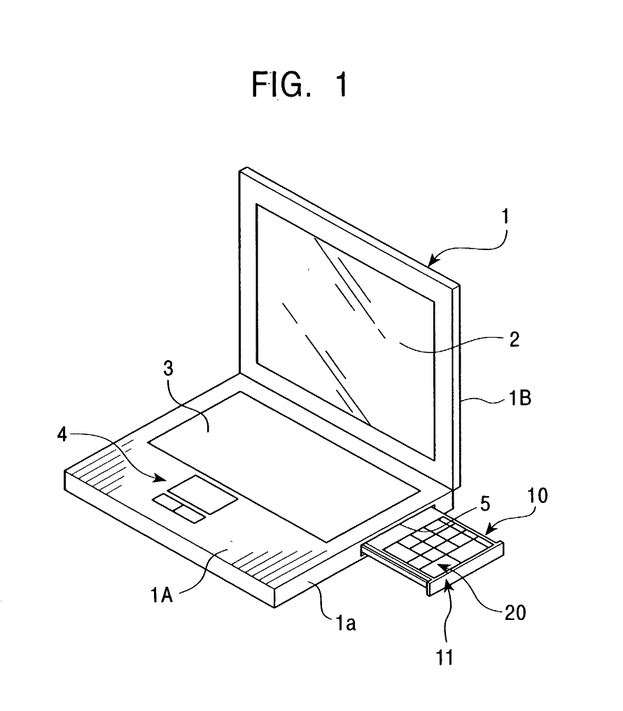

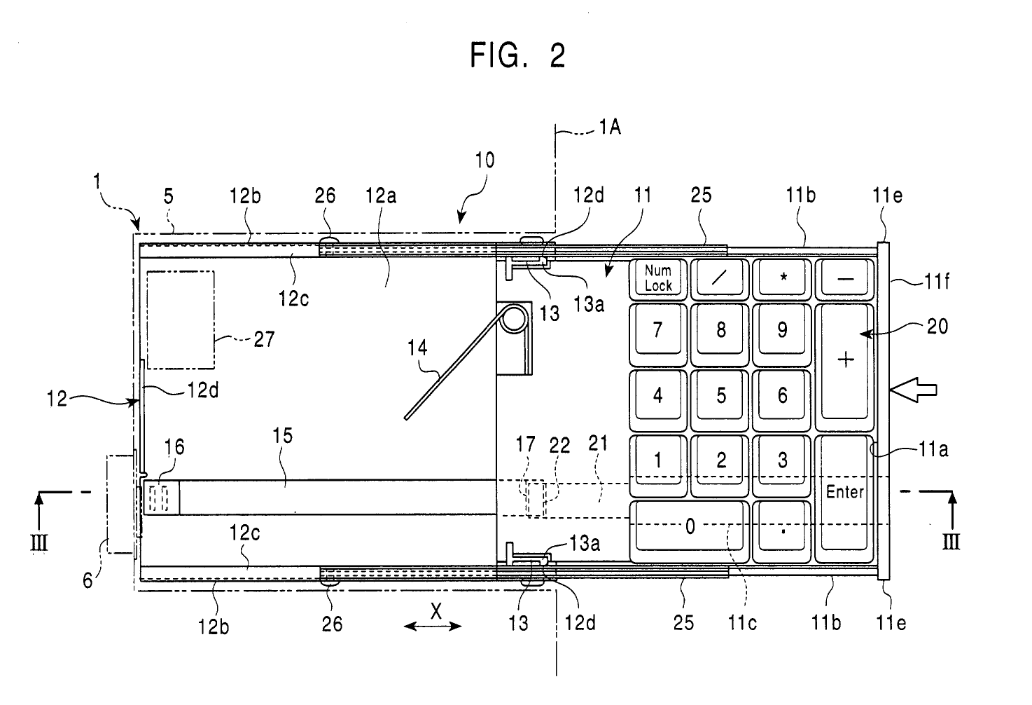

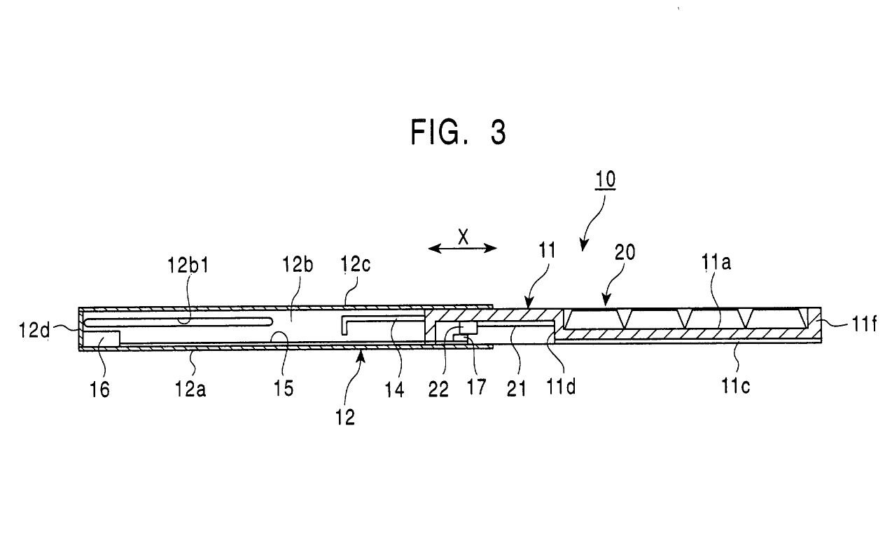

FIG. 1 is a perspective view of a notebook computer with a built-in unit of the present invention. FIG. 2 is a plan view showing a state when the built-in unit has been drawn out. FIG. 3 is a sectional view taken along line III-III of FIG. 2.

A computer 1 shown in FIG. 1 is a notebook computer and comprises a keyboard 3, which is a key input section; a base 1A having a pad-type pointing device 4 mounted thereto; and a cover 1B which is rotatably mounted to the base 1A which covers the keyboard 3 and the pointing device 4 when it is closed. A display section 2, which is a liquid crystal panel, is provided on the cover 1B. As shown in FIG. 1, when the case 1B is in the open posture as a result of being rotated upward, the display section 2 can be viewed.

A built-in unit 10 shown in FIG. 1 is used for numerical keypad input operations, and is provided in an accommodation space 5 opening towards a right side surface 1a of the base 1A of the computer 1. The accommodation space 5 may replaceably accommodate the built-in unit 10 or any one of the conventionally used FD, CD, and DVD drives.

As shown in FIG. 2, the built-in unit 10 has a synthetic resin tray 11, with a pad 20, which is a numerical keypad input section, being mounted to the top surface of the tray 11. As shown in FIG. 3, a square recess 11a facing the top surface is formed in the front portion of the tray 11, and the pad 20 is secured to the inside of the recess 11a. The tray 11 and the pad 20 may be integrally formed.

The pad 20 shown in FIG. 2 has 17 keys, which are numerical keys (0, 1, 2, . . . , 8, 9), operator keys (/, *, −, +), a decimal point key, an Enter key (“=” key), and a “Num Lock” key. The key configuration is not limited to that described above. The “Num Lock” key does not need to be provided.

Ribs 11b and 11b extending from the front end towards the back end of the tray 11 in the directions of a double-headed arrow X are integrally formed with both side surfaces of the tray 11. A pair of stopper members 13 and 13 are provided, one at each side of the back end of the tray 11. A torsion spring 14 is provided at the back end of the tray 11. When the torsion spring 14 is in a neutral state, one end of the torsion spring 14 is set protruding behind the tray 11.

Small protrusions 13a and 13a protruding sideways from the sides of the tray 11 are formed at the front ends of the respective stopper members 13 and 13 provided at the tray 11, and are resiliently deformable in directions orthogonal to the directions of the double-headed arrow X.

As shown in FIGS. 2 and 3, a recess-like groove 11c having the form of a strip extending in the directions of the double-headed arrow X and having a predetermined width is formed in the back side of the tray 11. A space, formed by a recess 11d facing a direction opposite to the direction that the recess 11a faces, is formed in the back portion of the back side of the tray 11. An electrically conductive member 21, formed into the shape of a strip extending in the directions of the double-headed arrow X, is provided at the top side of the recess 11d. The X-direction front end of the electrically conductive member 21 is electrically conductively connected to the numerical keypad 20, and the back end thereof is formed as a downwardly protruding connection terminal 22.

As shown in FIG. 2, the tray 11 is installed in a metallic chassis 12. The chassis 12 has side plates 12b and 12b, which are formed by vertically bending both ends of a bottom plate 12a. The top ends of the respective side plates 12b and 12b are bent portions 12c and 12c that are inwardly bent at right angles. A vertically upwardly bent upstanding portion 12d is formed at a portion of the back end of the base plate 12a.

Guide holes 12b1 and 12b1, which are elongated towards the back end from near the center in the directions of the double-headed arrow X, are formed in their respective side plates 12b and 12b (in FIG. 3, only one of the guide holes is shown). The tray 11 is inserted into the space between the side plates 12b and 12b. Engaging recesses 12e and 12e for engaging the small protrusions 13a and 13a are formed in the front end portions of the respective bent portions 12c and 12c of the chassis 12.

In the built-in unit 10, slide members 25 and 25 are provided between both side surfaces of the tray 11 and the side plates 12b and 12b of the chassis 12. The slide members 25 and 25 are formed by bending metallic plates, and have recess-like grooves formed in accordance with the protrusion shapes of the ribs 11b and 11b of the tray 11. The ribs 11b and 11b are inserted into the recess-like grooves, so that the ribs 11b and 11b can slide in the directions of the double-headed arrow X. Slide pins 26 and 26 are secured to the back ends of the respective slide members 25 and 25, and are slidably linked to the respective guide holes 12b1 and 12b1.

As shown in FIGS. 2 and 3, a strip-like circuit board 15 extending in the directions of the double-headed arrow X and having a predetermined width is secured to the top surface of the bottom plate 12a of the chassis 12. The circuit board 15 is, for example, a film-shaped flexible board or a glass epoxy resin board, and is disposed at a location where it overlaps the groove 13c. The circuit board 15 is formed so as to extend from the front end to the back end of the chassis 12. A connection terminal 16, disposed inside the accommodation space 5 of the computer and connected to a port 6 for internal connection, is provided at the back end of the circuit board 15, and an upwardly protruding connection terminal 17 is provided at the front end of the circuit board 15. A lock control member 27, which uses a heart cam, for locking and unlocking the tray 11 is provided towards the back of the chassis 12.

In the computer 1 of the embodiment, the pad 20 is at a protruding position when it protrudes from the accommodation space 5 of the computer 1 by a predetermined amount, and is at an accommodation position when it is completely accommodated inside the accommodation space 5 of the computer 1 and when a front surface 11f of the tray 11 has reached the same plane as the side surface 1a of the computer 1.

When the built-in unit 10 is at the accommodation position, the tray 11 is locked by the lock control member 27, so that the tray 11 does not protrude forward. At this time, the whole slide members 25 and 25 are accommodated inside the chassis 12. The tray 11 slides along the slide members 25 and 25 in order to be accommodated inside the chassis 12. The torsion spring 14 is in a suppressed state with respect to the upstanding portion 12d.

When the front surface 11f of the tray 11 at the accommodation position is pushed, the lock control member 27 unlocks the tray 11. The resilient restoring force of the torsion spring 14 pushes the tray 11 forward. At this time, the slide pins 26 provided at the respective slide members 25 and 25 slide forward in the respective guide holes 12b1 and 12b1, so that the tray 11 protrudes forward. When a person holds and draws out the tray 11 with his hand, the slide members 25 and 25 slide forward. When the slide pins 26 and 26 come into contact with the front ends defining the guide holes 12b1 and 12b1, the forward sliding movement of the slide members 25 and 25 is restricted. When the person draws out the tray 11 forward even more, the ribs 11b and 11b of the tray 11 slide in the recess-like grooves of the respective slide members 25 and 25, so that the tray 11 protrudes further out. This causes the pad 20 to be in a completely exposed state and to reach the protruding position.

At the protruding position, the engaging members 13 and 13 engage the respective engaging recesses 12e and 12e and are locked, thereby preventing the tray 11 from accidentally sliding into the accommodation space 5.

When the tray 11 reaches the protruding position, the connection terminal 22 at the pad 20 side and the connection terminal 17 at the chassis 12 are brought into contact and electrical conduction with each other for the first time. Therefore, a signal of the pad 20, mounted in the built-in unit, does not adversely affect a circuit in the base 1A when the pad 20 is accommodated.

The connection terminal 17 is switching means for bringing the numerical keypad 20 and the circuit in the base 1A into electrical conduction with each other when the tray 11 is in a protruding state. A switching section for interrupting electrical conduction with a connection circuit in the case where the pad 20 and the circuit in the base 1A are previously connected through the connection circuit may be provided. In this case, a switch is used to make a detection that the tray 11 is in the protruding state in order to bring the connection circuit into an electrically conductive state, and, when the tray 11 reaches the accommodation position, the connection circuit is disconnected.

In the built-in unit 10, as described above, the groove 11c of the tray 11 and the circuit board 15 are positioned so as to overlap in the vertical direction. Accordingly, the circuit board 15 passes through the groove 11c when the tray 11 slides, so that the circuit board 15 does not interfere with the accommodation and the drawing out of the tray 11.

In the case where the built-in unit 10 is to be slid from the protruding position to the accommodation position, when a person pushes the front surface 11f of the tray 11 with his hand or finger in the direction of a larger arrow shown in FIG. 2, the pushing force unlocks the small protrusions 13a and 13a and the engaging recesses 12e and 12e from each other, so that the tray 11 can slide into the accommodation space 5. At this time, in the tray 11, the ribs 11b and 11b slide in the recess-like grooves of the respective slide members 25 and 25, so that protrusions 11e and 11e, one provided at each end of the front surface 11f of the tray 11, come into contact with the front ends of the slide members 25 and 25. Then, the tray 11 is pushed backward along with the slide members 25 and 25, so that the slide pins 26 and 26 slide to the back ends of the guide holes 12b1 and 12b1, as a result of which the tray 11 reaches the accommodation position.

Although a USB interface may be selected as an interface for use when the built-in unit 10 is being connected to the computer 1, other types of interfaces may be used.

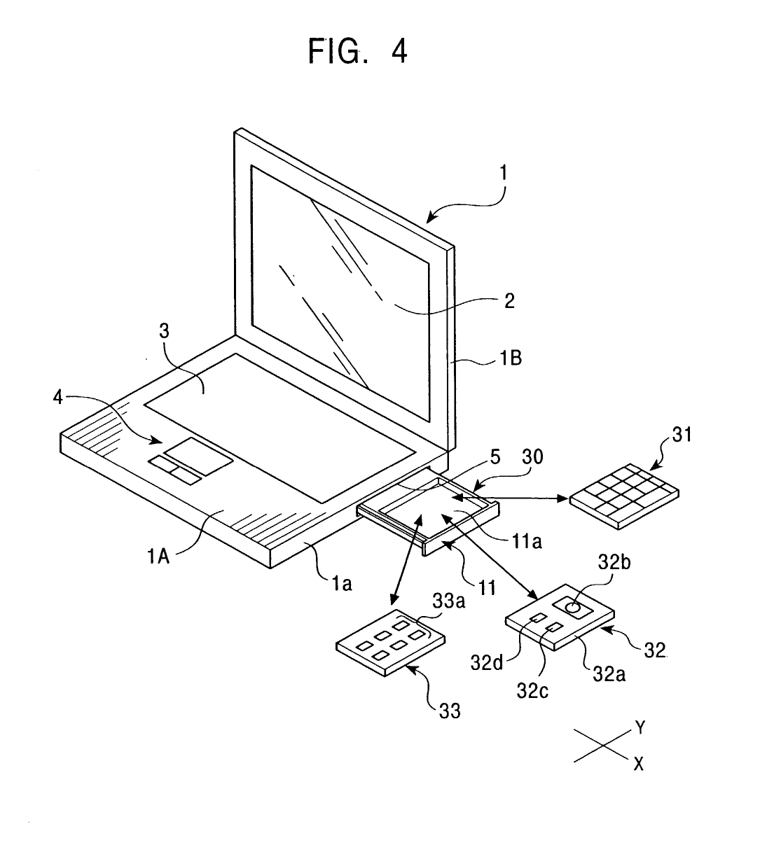

FIG. 4 is a conceptual diagram of a computer of a second embodiment of the present invention. The computer of the second embodiment has the same structure as the computer of the first embodiment except that a portion of the structure of a built-in device differs from the built-in device 10.

In a built-in device 30 used in the second embodiment, various input devices can be replaceably set on a tray 11.

As shown in FIG. 4, input devices 31, 32, and 33, any one of which may be selected in order to be set onto the built-in unit 30, are, for example, the numerical keypad, a pointing device 32, and a USB hub 33. However, the choices are not limited to those mentioned above, so that, for example, a tablet which allows input of characters, symbols, and pictures using a pen, or a printer may be chosen.

The input device 32 has a knob 32b slidably provided on the top surface of a case 32a. Sliding the knob 32b in the X-Y direction makes it possible to input coordinates. In the input device 32, an X movable member, which moves when the knob 32b is slid in the X direction, and a Y movable member, which moves when the knob 32b is slid in the Y direction, are provided inside the case 32a. In addition, in the input device 32, detecting means for detecting the locations of the X movable member and the Y movable member by a variable resistor is provided, so that the X and Y coordinates can be detected. Operation buttons 32c and 32d having push-type switching elements which can be switched on and off are provided near the knob 32b. Resilient restoring means (not shown) for moving the knob 32b towards the center at all times may be provided at the knob 32b.

In the input device 32, a mouse cursor displayed on a display section 2 of a computer 1 can be moved to a desired location within a screen in accordance with the direction of movement of the knob 32b. By pressing the operation buttons 32c and 32d, a button on the screen can be clicked, a menu can be displayed, etc. When the input device 32 is provided, compared to a stick-type or pad-type pointing device, it becomes easier to perform delicate operations such as minutely moving the cursor.

The input device 33 has a connector corresponding to a plurality of USB interfaces provided on the top surface of the case. Therefore, peripheral devices corresponding to the various types of USB interfaces can be connected.

In the second embodiment, mounting-and-removing means for removably mounting any one of the various input devices 31 to 33 to the tray 11 is provided. The mounting-and-removing means has a male connector and a female connector for connecting the tray 11 and any one of the input devices 31, 32, and 33 and bringing them into electrical conduction with each other. A connector at the tray 11 side is connected to the connection terminal 22. When the built-in unit 30 reaches the protruding position, it can be brought into electrical conduction with a circuit in a base 1A of the computer 1.

In this way, in the second embodiment, various input devices can be replaceably used, so that various input operations can be performed in a limited space.

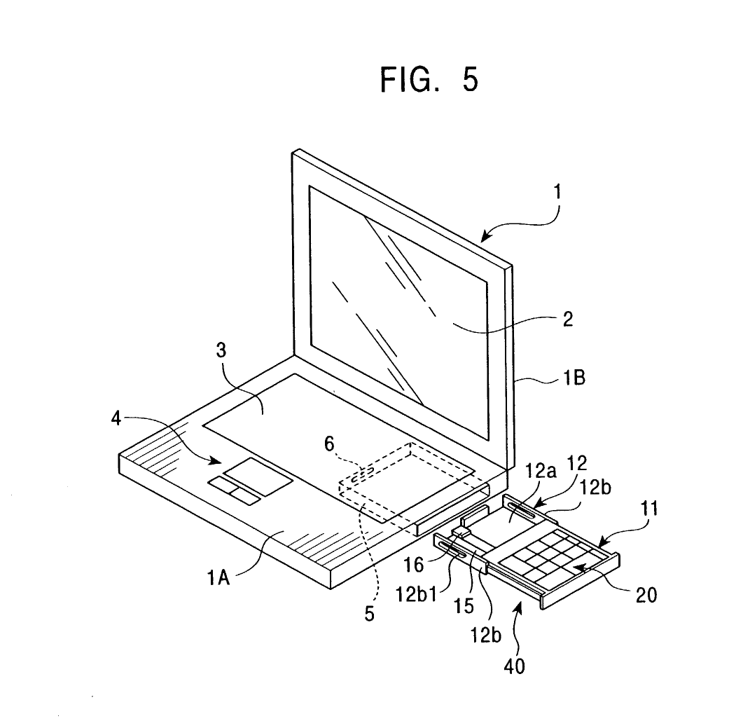

FIG. 5 is a perspective view of a computer of a third embodiment of the present invention. A built-in device 40, mounted in a computer 1 shown in FIG. 5, has the same structure as the built-in device 10 used in the first embodiment, but is made mountable to and removable from a base 1A of the computer 1. In other words, the built-in device 40 can be removed from a chassis 12 including a tray 11. The built-in device 40 may also have the same structure as the built-in device 30, but made mountable to and removable from the base 1A.

In the present invention described above, even if the computer does not have an input section exclusively for a numerical keypad as the notebook type does, kana input operation and numerical keypad input operations can be carried out using different keys, so that it becomes easier to perform the numerical keypad input operations, and installation space does not need to be provided. In addition, in the present invention, various input operations can be performed in a limited space.

What is claimed is:

1. A computer comprising:
a base having a key input section;
a built-in unit provided at a side portion of the base, the built-in unit being capable of sliding between an accommodation position where the built-in unit is accommodated inside an accommodation space inside the base and a protruding position where the built-in unit protrudes from the inside of the base, the built-in unit including an input section having a numerical keypad; and
switching means, disposed between the base and the built-in unit, for performing a switching operation so that, when the built-in unit is at the protruding position, a numerical keypad operation signal from any one of the numerical keypad keys can be applied to a circuit in the base.

2. A computer according to claim 1, wherein the key input section on the base does not have an input section exclusively for the numerical keypad.

3. A computer according to claim 1, wherein the base is a portion of a notebook personal computer.

4. A computer according to claim 1, wherein the built-in unit can be mounted to and removed from the base.

5. A computer comprising:
a base having a key input section;
a built-in unit provided at a side portion of the base, the built-in unit being capable of sliding between an accommodation position where the built-in unit is accommodated inside an accommodation space inside the base and a protruding position where the built-in unit protrudes from the inside of the base, the built-in unit being such that various types of input devices can be replaceably mounted thereto; and
switching means, disposed between the base and the built-in unit, for performing a switching operation so that, when the built-in unit is at the protruding position, an operation signal of the input device can be applied to a circuit in the base.

6. A computer according to claim 5, wherein the built-in unit can further have a recording medium driving device mounted thereto.

7. A computer according to claim 5, wherein the base is a portion of a notebook personal computer.

8. A computer according to claim 5, wherein the built-in unit can be mounted to and removed from the base.
